(19) United States
(12) Patent Application Publication
(10) Pub. No.: US 2025/0291121 A1
(43) Pub. Date: Sep. 18, 2025

(54) Precision Out-of-Channel Alignment Feedback for Optical Circuit Switching

(71) Applicant: Bright Silicon Technologies, Inc., Livermore, CA (US)

(72) Inventors: Robert Matthew Panas, Livermore, CA (US); Eric Weflen, San Francisco, CA (US); Ryan Lee, Livermore, CA (US)

(21) Appl. No.: 19/226,222

(22) Filed: Jun. 3, 2025

Related U.S. Application Data
(63) Continuation-in-part of application No. PCT/IB25/51700, filed on Feb. 17, 2025.
(60) Provisional application No. 63/554,920, filed on Feb. 16, 2024.
(60) Provisional application No. 63/641,938, filed on May 2, 2024.

(51) Int. Cl. G02B 6/35

(52) U.S. Cl. CPC G02B 6/3588; G02B 6/3512

(57) ABSTRACT

A system for aligning optical signals includes data sources, data receivers, alignment signal sources and receivers, and a steering array. The steering array includes of alignment steering elements and each element is configured to adjustably direct light in a specified direction until the reflected light on a receiver is maximized. The system includes data steering elements configured to direct a signal from a set of sources in a respective specified direction. The system includes a controller that is configured to determine a change in a nominal position command vector. The controller is configured to determine a command vector for a path between a selected set of data sources and a selected set of data receivers based on the change in the nominal position command vector and a first command. The command controller is configured to establish the optical path between the selected data sources and the selected data receivers.

### CROSS-REFERENCE TO RELATED APPLICATIONS

This application is a continuation-in-part of PCT International Application No. PCT/IB2025/051700 filed Feb. 17, 2025 (Attorney Docket No. 52753-23), which claims the benefit of U.S. Provisional Application No. 63/554,920 filed Feb. 16, 2024 (Attorney Docket No. 52753-12) and U.S. Provisional Application No. 63/641,938 filed May 2, 2024 (Attorney Docket No. 52753-17).

### FIELD

The present disclosure relates to optical connections and more particularly to optical circuit switches.

### BACKGROUND

Modern data centers rely on circuit switching to create a network between network nodes via a dedicated communications channel (a circuit). The reliability and speed of such networks are highly dependent on the circuit switches which route and form the circuit. In recent years, traditional copper cabling has given way to fiber optic cables which generally provide greater capacity with less signal loss and interference. However, fiber optic circuit switches require specialized and complex systems to maintain accuracy and reliability.

Insertion loss, which measures optical power transfer efficiency of the switch (optical power out divided by optical power in) is a primary parameter of an OCS. Any misalignment that results in lost light increases the insertion loss and degrades the performance of the OCS.

A common optical circuit switch (OCS) architecture uses an array of input ports—that is, light sources, such as fiber, lasers, and/or light emitting diodes (LEDs)—aligned via a collimator array to steer light to an input array of steering elements, then to a second output array of steering elements, and finally to an output collimator array and output port array—that is, light detectors, such as fiber. Some architectures include over 100 inputs and over 100 outputs. This design allows for flexibility in switching light from input to output ports. However, OCS architecture poses significant stability and reliability challenges with regards to maintaining alignment of the steered light because the light must be precisely aligned across free space gaps on the scale of 0.1-1 μm to focus into the fiber (or other light detector), which has a core of around 10 μm. This alignment must be maintained while the OCS architecture is distorting due to humidity, air pressure, vibration, creep, hysteresis, and/or thermal variation in the surrounding environment. Variations on the scale of a single micron (1 μm) are sufficient to increase insertion loss throughout the switch. In some implementations, other non-fiber optical components like chiplets are used as light sources and detector ports instead of fiber ports. In some implementations, chiplets include microLEDs, micro-lasers, and/or micro-photodetectors. These chiplets require similar precision with a single micron of misalignment resulting in loss.

The OCS must efficiently route the light from an input port to an output port with minimal loss, minimal cross-talk, and be able to change the connection in minimal time. A typical OCS uses an array of light sources to launch signals through an array of small lenses, where each lens is located at the end of each fiber (or light source). The output from a steering array in an OCS is generally desired to be a parallel set of beamlets aligned to the primary optical axis of the architecture, where each beamlet may be collimated or diverging depending on the optical setup. The lenses are intended to collimate the light from each fiber (or other light source) and focus it onto a specific steering element.

A major challenge in OCS design is ensuring the collimator array and light source array fabrication are tightly controlled both during manufacturing and during operation to ensure proper emission angle on the collimated beam. Any error in the beam angle results in error displacement of the beam on the surface of the steering element. Error displacement causes an increase of insertion loss and can cause cross-talk with other channels (i.e., data from an input is detected at an output other than the intended output).

The high precision required for efficient OCS operation stresses fabrication tolerances which results in decreased yield, increased costs, and acts as a point of sensitivity to small structural distortions (e.g., thermal and/or mechanical) during operation. Even if perfectly calibrated after initial assembly, the alignment will change during the varying mechanical and thermal loads on the OCS, resulting in cross talk and insertion loss. Sensitivity during operation poses a major challenge to OCS designs as compensation generally requires either extreme materials, extreme manufacturing tolerances or active elements in the design that add cost, complexity, and power draw.

There is increasing demand for OCS performance improvements in the domain of insertion loss. Any misalignment that results in lost light increases insertion loss and increased insertion loss requires additional power to ensure the signal reaches its endpoint. Reduced insertion loss allows a larger quantity of OCSs to be chained together, creating a more broadly linked data center.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system for aligning optical signals system includes a set of data sources, a set of data receivers, a set of alignment signal sources, a set of alignment signal receivers, and a first steering array including a set of alignment steering elements. Each alignment steering element is configured to adjustably direct incident light in a specified direction, and for each alignment steering element of the set of alignment steering elements, reflect light from a set of light sources and adjust the alignment steering element until the reflected light incident on a respective receiver is maximized. The first steering array includes a plurality of data steering elements. Each data steering element is configured to direct a signal from a respective subset of sources of the set of data sources in a respective specified direction. The system includes a command controller that is configured to determine, based on adjustments from the set of alignment steering elements, a change in a nominal position command vector. The command control is configured to determine an overall command vector for an optical path between a selected set of data sources of the set of data sources and a selected set of data receivers of the set of data receivers based on the change in the nominal position command vector, and a first command of a set of relative position commands. The first command corresponds to a combination of the selected set of data sources and the selected set of data receivers. The command controller is configured to establish the optical path between the selected set of data sources and the selected set of data receivers by executing the overall command vector.

In other features, each alignment steering element of the set of alignment steering elements is configured to reflect light from a plurality of light sources. In other features, each data steering element of the set of alignment steering elements is configured to direct a plurality of signals from the respective subset of sources.

In other features, the set of data sources includes a set of light stations each configured to transmit and detect light simultaneously. In other features, the set of data receivers includes a set of light stations each configured to transmit and detect light simultaneously. In other features, the respective subset of sources includes a bundle of optical fibers. In other features, each data source of the set of data sources corresponds to a unique collimator.

In other features, the system includes a second steering array. The specified direction corresponds to the second steering array, and the respective receiver is physically linked to the second steering array. In other features, the first steering array is physically linked to a first subset of alignment signal sources and a first subset of alignment signal receivers. In other features, the second steering array is physically linked to a second subset of alignment signal sources and a second subset of alignment signal receivers. In other features, the set of data sources are physically linked to a third subset of alignment signal sources and a third subset of alignment signal receivers. In other features, the set of data receivers are physically linked to a fourth subset of alignment signal sources and a fourth subset of alignment signal receivers.

In other features, the system includes a set of calibration elements. A first element of the first steering array includes a first subset of calibration elements, the first element is maneuvered via a set of paddles, and a position of the set of paddles is indicated by the first subset of calibration elements. In other features, determining the overall command vector includes summing the nominal position command vector and the first command of the set of relative position commands.

In other features, each member of the set of relative position commands corresponds to a combination of one input source of the set of data sources and one data receiver of the set of data receivers. In other features, the set of relative position commands includes a respective command for every possible combination of one data source of the set of data sources and one data receiver of the set of data receivers.

In other features, the command controller is configured to determine the overall command vector in response to a request that designates the selected data source and the selected data receiver. In other features, the set of alignment steering elements is repeatedly calibrated and the plurality of data steering elements are repeatedly calibrated.

In other features, the set of data sources, the set of data receivers, set of alignment signal sources, the set of alignment signal receivers, the set of alignment steering elements, and the plurality of data steering elements are time stable. In other features, the nominal position command vector includes commands to align a first data source of the set of data sources with a corresponding data receiver of the set of data receivers.

In other features, the plurality of data steering elements are each configured to adjustably direct incident light in a specified direction, and for each alignment steering element of the set of alignment steering elements, reflect light from a light source, and adjust the alignment steering element until the reflected light incident on a respective receiver is maximized.

In other features, the command controller is configured to store adjustments from the plurality of data steering elements, and determine, based on the stored adjustments from the plurality of data steering elements, a change in the set of relative position commands.

In other features, the set of data sources and the set of data receivers include a set of fiber optic cables. In other features, the command controller is configured to determine adjustments based on data from the set of alignment steering elements. In other features, the command controller is configured to receive the adjustments from the set of alignment steering elements. In other features, the information encoding the set of relative position commands includes at least one of a look-up table (“LUT”), an equation, or stored information.

A method for aligning optical signals of an optical system includes adjustably directing incident light, via a set of alignment steering elements of a first steering array, in a specified direction. The method includes, for each alignment steering element of the set of alignment steering elements reflecting light from a set of light sources, and adjusting the alignment steering element until the reflected light incident on a respective receiver is maximized. The method includes, for each data steering element of a plurality of data steering elements of the first steering array, directing a respective signal from a respective subset of data sources of a set of data sources in a respective specified direction. The method includes determining, based on adjustments from the set of alignment steering elements, a change in a nominal position command vector. The method includes determining an overall command vector for an optical path between a selected set of data sources of the set of data sources and a selected set of data receivers of a set of data receivers based on the change in the nominal position command vector, and a first command of a set of relative position commands. The first command corresponds to a combination of the selected set of data sources and the selected set of data receivers. The method includes establishing the optical path between the selected set of data sources and the selected set of data receivers by executing the overall command vector.

In other features, the specified direction corresponds to a second steering array and the respective receiver is physically linked to the second steering array. In other features, the first steering array is physically linked to a first subset of alignment signal sources and a first subset of alignment signal receivers. In other features, the second steering array is physically linked to a second subset of alignment signal sources and a second subset of alignment signal receivers. In other features, the set of data sources are physically linked to a third subset of alignment signal sources and a third subset of alignment signal receivers. In other features, the set of data receivers are physically linked to a fourth subset of alignment signal sources and a fourth subset of alignment signal receivers.

In other features, a first element of the first steering array includes a first subset of calibration elements. In other features, the first element is maneuvered via a set of paddles. In other features, a position of the set of paddles is indicated by the first subset of calibration elements. In other features, determining the overall command vector includes summing the nominal position command vector and the first command of the set of relative position commands. In other features, each member of the set of relative position commands corresponds to a combination of one input source of the set of data sources and one data receiver of the set of data receivers. In other features, the set of relative position commands includes a respective command for every possible combination of one data source of the set of data sources and one data receiver of the set of data receivers. In other features, the nominal position command vector includes commands to align a first data source of the set of data sources with a corresponding data receiver of the set of data receivers.

A non-transitory computer-readable storage medium stores processor-executable instructions for aligning optical signals. The instructions include adjustably directing incident light, via a set of alignment steering elements of a first steering array, in a specified direction. The instructions include, for each element of the set of alignment steering elements, reflecting light from a set of light sources, and adjusting the alignment steering element until the reflected light incident on a respective receiver is maximized. The instructions include, for each data steering element of a plurality of data steering elements of the first steering array, directing a respective signal from a respective subset of data sources of a set of data sources in a respective specified direction. The instructions include determining, based on adjustments from the set of alignment steering elements, a change in a nominal position command vector. The instructions include determining an overall command vector for a path between a selected set of data sources of the set of data sources and a selected set of data receivers of a set of data receivers based on the change in the nominal position command vector, and a first command of a set of relative position commands. The first command corresponds to a combination of the set of selected data sources and the selected set of data receivers. The instructions include establishing the optical path between the set of selected data sources and the selected set of data receivers by executing the overall command vector.

In other features, the specified direction corresponds to a second steering array, and the respective receiver is physically linked to the second steering array. In other features, the first steering array is physically linked to a first subset of alignment signal sources and a first subset of alignment signal receivers, the second steering array is physically linked to a second subset of alignment signal sources and a second subset of alignment signal receivers, the set of data sources are physically linked to a third subset of alignment signal sources and a third subset of alignment signal receivers, and the set of data receivers are physically linked to a fourth subset of alignment signal sources and a fourth subset of alignment signal receivers.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an example of a common optical circuit switch (OCS) architecture with two steering arrays.

FIG. 2 is an example of positional changes in OCS architecture.

FIG. 3 is an example of parameter changes in OCS architecture.

FIGS. 4A-4B are an example of updating alignment in OCS steering arrays with out-of-channel sensing elements.

FIG. 5 is an example steering array with out-of-channel sensing elements.

FIG. 6 is a block diagram of an example system for precision out-of-channel sensing.

FIGS. 7A-7B are flowcharts of an example method for aligning out-of-channel sensing elements.

FIG. 8 is a flowchart of an example method for updating calibration of steering elements.

FIG. 9 is a flowchart of an example method for aligning an optical input port with an optical output port.

In the drawings, reference numbers may be reused to identify similar and/or identical elements.

### DETAILED DESCRIPTION

### Out-of-Channel Alignment Feedback Introduction

The present disclosure describes a system for achieving high stability, low optical loss, and actively monitored alignment between ports in an optical circuit switch (OCS). The present disclosure avoids drawbacks of active alignment schemes including the cost, complexity, and power losses associated with sensing on each port. While the disclosure focuses on a particular input and output port architecture, the same approach can be applied to other OCS architectures. Similarly, while optical fibers (including fiber arrays used as input and output sources) are frequently described throughout the disclosure, the approaches, structures, methods, and systems described below are equally applicable to systems that use alternatives to fiber, including various other light sources, light detectors, and light transmission media (such as chiplets, microLEDs, micro-lasers, and/or micro-photodetectors).

In various embodiments, an input and/or output port includes a single optical data source. In various embodiments, an input and/or output port includes two or more optical data sources. For example, an input and/or output port may include a bundle of optical sources (such as fiber, lasers, etc.) pointed at a single steering element, which results in more optical input and/or output sources than steering array elements. In various embodiments, each source of the bundle of optical sources corresponds to a collimator unique to the source.

In various embodiments, there are an equal number of input ports and output ports. In various embodiments, the number of input ports and output ports and not equal. In various embodiments, data ports act as both optical sources and detectors. For example, a data port can transmit an optical signal and receive another optical signal simultaneously. Together, light sources and light detectors are generically referred to as light stations. In various embodiments, each light station includes a single optical data source/detector. In various embodiments, a light station includes two or more optical data sources/detectors. For example, a light station may include a bundle of optical fibers or lasers pointed at a single steering element, which results in more light stations than steering array elements. In various embodiments, each source/detector of the bundle of optical sources/detectors corresponds to a collimator unique to the source/detector.

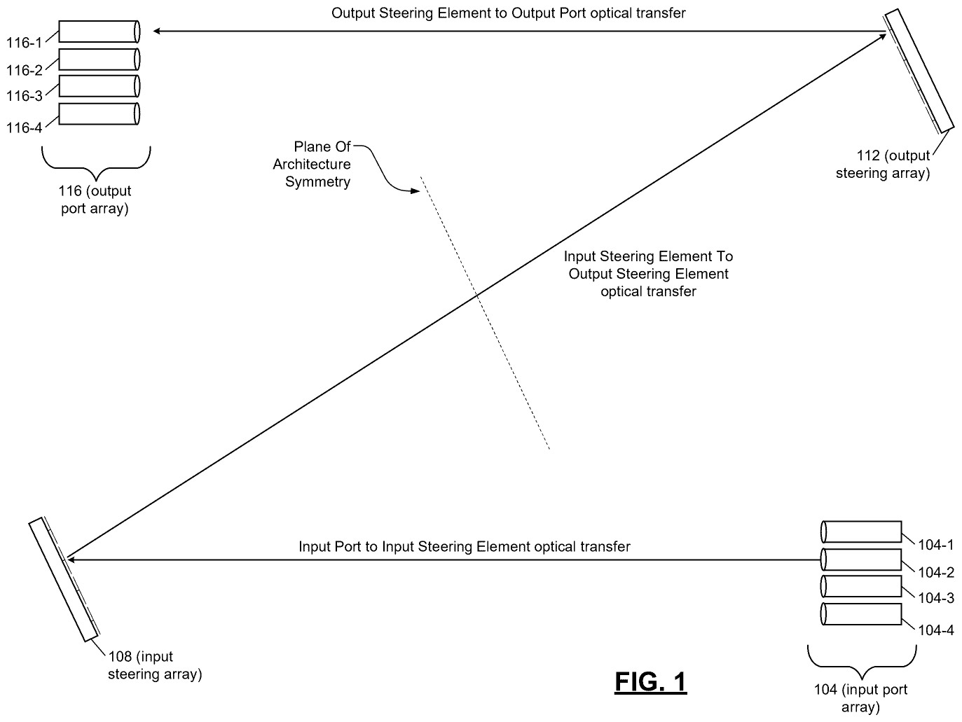

FIG. 1 is an example of a common OCS architecture including input port array 104, input steering array 108, output steering array 112, and output port array 116. Input port array 104 includes input port 104-1, input port 104-2, input port 104-3, and input port 104-4. In some implementations, input port array 104 includes more than four input ports (e.g., 10, 100, 500, or 1000 ports). Output port array 116 includes output port 116-1, output port 116-2, output port 116-3, and output port 116-4. In some implementations, output port array 116 includes a more than four output ports (e.g., 10, 100, 500, or 1000 ports). In this example, a data signal (such as an optical signal) is transmitted (via laser) from an input port (such as input port 104-2) on input port array 104. The signal is then reflected by a steering element in input steering array 108 into a steering element on output steering array 112. Finally, the signal is reflected into an output port (such as output port 116-1) on output port array 116.

### Shortcomings of Existing Ocs Architectures

Electrostatic micro-electro-mechanical systems (MEMS) are a common solution for steering elements in OCS architectures. A voltage command (or multiple voltage command vector) is supplied to an electrostatic MEMS, which generates specific motion responses. However, the response of a MEMS may change over time as the performance parameters change. For example, an electrostatically actuated MEMS may be sensitive to:
i) electrostatic charge buildup producing non-zero actuation forces,
ii) Young's Modulus variation with temperature changing the force-to-position mapping, iii) equilibrium orientation variation due to stress balance variation with temperature, iv) equilibrium orientation variation due to hysteresis,
v) equilibrium orientation variation due to creep, and vi) optical coupling effects including localized heating. All of these effects alter the electrical-to-mechanical transformation for a steering element and create issues for port-to-port alignment repeatability in OCS architectures.

A common 2D array OCS architecture (as seen in FIG. 1) requires a four degrees of freedom (4DOF) command vector to be specified for each port-to-port mapping. The 4DOF command includes two specific 2D commands (such as tip and tilt) for both the input and output steering arrays. Finding the port-to-port command vector relies on the stability of the OCS and architecture level calibration done on the whole OCS after assembly, when the input and output steering arrays can each be scanned over their range of motion to find the specific ports. A unique 4D command vector can then be extracted as the vector which maximizes the output port signal for a given input port (m) and output port (n). A lookup table can then be created for all possible m and n combinations, which is used during regular operation. The created 4D command vector will always be the optimal solution if the OCS architecture is completely stable (i.e., without performance variation over time). However, OCS architectures are not completely stable and variation is commonplace in OCS systems. Therefore, the true 4D command vector for any given input and output port combination will change over time.

Other approaches rely on in-operation feedback to adjust (in real-time during operation) the 4D command vector to achieve a desired port-to-port alignment via an in-channel alignment signal (i.e., within the channel of a data signal beam). An in-channel signal shares the same physical optical path as data signals rather than a spectral channel. In some implementations, an in-channel signal differs in frequency from the data signal. In-channel alignment requires in-channel sensing for the alignment signal to be detected. In-channel signal sensing includes two primary approaches: i) tapping, wherein a fraction of the data signal is read from the output fiber for feedback purposes, and ii) as a separate signal injected into the signal early in the OCS architecture, then extracted from the signal at a later part of the architecture.

In-channel sensing via tapping into the output fiber signal provides full end-to-end measurement, allowing all possible errors in the system to be captured by the alignment measurement. A full measurement approach such as tapping provides high precision, but often results in power loss for the primary data signal due to the tap on the output fiber signal. It also requires additional equipment for each tap that can significantly raise the cost and complexity of the OCS.

In-channel sensing via injecting a separate frequency beam and extracting that within the OCS architecture provides partial measurement of the architecture errors. Errors in the architecture before the alignment signal injection location and after the extraction location are not captured by the alignment measurement. The partial measurement approach results in un-captured error, (which may cause larger port-to-port alignment error than full measurement approaches) but will not significantly attenuate the primary data signal.

Both in-channel approaches result in unwanted optical losses through the OCS. In-channel active feedback approaches, whether partial or full measurement, resolve the issue of tracking the time-changing optimal 4D command vector. This lowers the scale and variability of link insertion loss. In-channel active feedback brings significant feedback hardware complexity, cost, and power use, as the feedback must be implemented in-channel within each channel in the array, thus the hardware requirements scale with the array size.

Out-of-channel approaches have been proposed, however these designs also have significant drawbacks. For example, in some implementations, a separate control beam is reflected off the steering elements along a different path from the data signal beam such that it can be steered to a position sensitive detector (PSD). The reading on the PSD can then be used to monitor changes in the steering elements. This approach provides only partial measurement of the alignment errors in the OCS architecture thus resulting in significant potential alignment error.

Another approach includes a combination of in-channel and out-of-channel sensing. However, existing combination methods fail to provide the accuracy that would enable high precision measurement, are unable to account for significant unmeasured alignment error added by the control feedback structures, and/or are unable to account for the time variation of the steering elements inherent in the design—resulting in improper alignment. Thus, there is a need for an OCS port-to-port alignment approach which provides the benefit of the in-channel high accuracy active alignment approach without the drawback of other in- and out-of-channel approaches.

### Precision Out-of-Channel Continuous Alignment Protocol

Precision Out-of-Channel Continuous Alignment Protocol (POCCAP), as various implementations of the present disclosure are named, achieves active feedback alignment for each port without using in-channel sensing while overcoming the drawbacks of current out-of-channel solutions. POCCAP provides the benefit of the active alignment in-channel sensing approach without the drawbacks of typical in-channel sensing solutions including: i) additional optical losses, ii) injection of unmeasured alignment errors, and iii) additional hardware scaling at the per-element level. POCCAP uses out-of-channel sensing and thus avoids additional optical loss and additional hardware scaling at the per-element level, unlike prior in-channel sensing designs. The use of continuously calibrated and time stable elements (specifically the steering elements) resolves the issue of time stability found in prior out-of-channel sensing approaches and thus allows for commands on un-sensed elements to be inferred from neighboring sensed elements. This is a key component for achieving the benefit of in-channel sensing without the drawbacks of in-channel sensing. The use of alignment sensing ports physically linked to primary optical elements avoids the issues with prior out-of-channel calibration and feedback sensing approaches which inject additional alignment error to the measurements.

POCCAP provides precision full measurement feedback alignment, which ensures low-loss port-to-port links. POCCAP generally relies on four features in the OCS architecture: i) continuously calibrated elements, ii) time stable element performance for all primary elements, iii) dedicated out-of-channel alignment sensing ports physically linked to primary optical elements to measure array level changes in the OCS architecture, and iv) a way to determine the relative 4D command vector for a given desired data port-to-port alignment. In operation, the POCCAP controller combines the relative 4D command vectors with the corrections generated by the out-of-channel alignment measurements. POCCAP enables a system whose port-to-port alignment for data channels can be tracked and actively maintained in operation by dedicated sense channels without impeding the operation of the data channels.

### Continuously Calibrated Array

The first feature of the POCCAP approach is a continuously calibrated array. The standard steering array used in an OCS is not a continuously calibrated array. In standard OCS architecture, an uncalibrated array is controlled with a command electrical signal (such as a voltage) which is translated through the steering element electromechanical response to produce a steering position such as a tip/tilt location. Uncalibrated operation can be used when treating the system as a black box for finding the commands to achieve a specific orientation, however each achieved steering position must have been previously mapped. There is no algorithm capturing the transformation from electrical command to achieved steering position, so adjustments of the steering position into unmapped regions cannot be achieved with high accuracy. Therefore, the system cannot accurately implement small changes in steering position around the previously mapped points, instead the system can only accurately shift between pre-mapped locations. When the system does not change with time, the ideal alignments can be pre-mapped and uncalibrated operation is possible. When the system changes with time, uncalibrated operation will result in errors as the required alignment will deviate from the pre-mapped alignment.

The proposed solution employs a continuously calibrated steering array which includes an element calibration transform between the user supplied calibrated input and the electrical command into the steering element. The steering element is functionally a transformation from the electrical domain (the command) to the mechanical domain (the physical position), and the calibration is the mathematical inverse transformation. The calibration modifies user input so that the supplied user input maps to the desired steering position (preferably via a 1:1 mapping where both input and output are of the same units). The calibrated input is in the form and domain of a steering position command, while the uncalibrated input is in a different form and domain of electrical commands. Calibrated inputs directly represent steering position outputs, meaning that command vectors for calibrated elements are position command vectors.

Calibrated operation enables the system to accurately implement small changes in steering position around the previously mapped points. Properly calibrated elements show an equivalence in relative response such that a given position command vector change produces the same steering element positional change for all the calibrated elements. This equivalence provides the performance effect relied on by POCCAP, enabling position command changes observed on one channel to be accurately transferred to other unobserved channels. The change in the position command vector to a calibrated element can accurately be read as the change in the actual element position, and accurately transferred to other elements. This can only be achieved with systems that are continuously calibrated.

Steering elements are considered calibrated when the mapping of the given position command vector to an equivalent elemental position change is accurate at the time of consideration. One time calibration states create a temporarily calibrated steering element, however steering element electrical-to-mechanical performance parameters change over time so the steering element will gradually become uncalibrated, as described above. The combination of charge buildup, material property variation due to optical heating, environmental change, hysteresis, and creep alter the electrical-to-mechanical transformation for a steering element. If these effects are not tracked and compensated, then the steering elements will quickly lose their calibration.

One method of mitigating calibration loss uses devices with extensive design symmetries to cancel at least most out the changes, but this will not resolve all changes. A second, more robust way of compensating for the effects is with active feedback. Capacitive-based positional feedback, as one example, provides a solution to ensuring continuously calibrated elements as capacitance measurements operate by observing charge flow on/off the capacitors, producing a measurement which is independent of the static charge on the device, the material Young's modulus, or the equilibrium stress distribution. The feedback thus ensures the steering element retains the same positional response to a given position command vector, definitionally remaining continuously calibrated. In some implementations, each steering element is controlled (and maneuvered) via a group of adjustable paddles whose position is measured by capacitance sensing.

### Time Stable Performance

The second feature of POCCAP is the time stable performance of the OCS elements, which is easily achieved once all elements are continuously calibrated. There are two main types of changes in the OCS architecture: position and parameter. Position type changes are easily observed and compensated for. However, parameter type changes are more difficult to observe and compensate for.

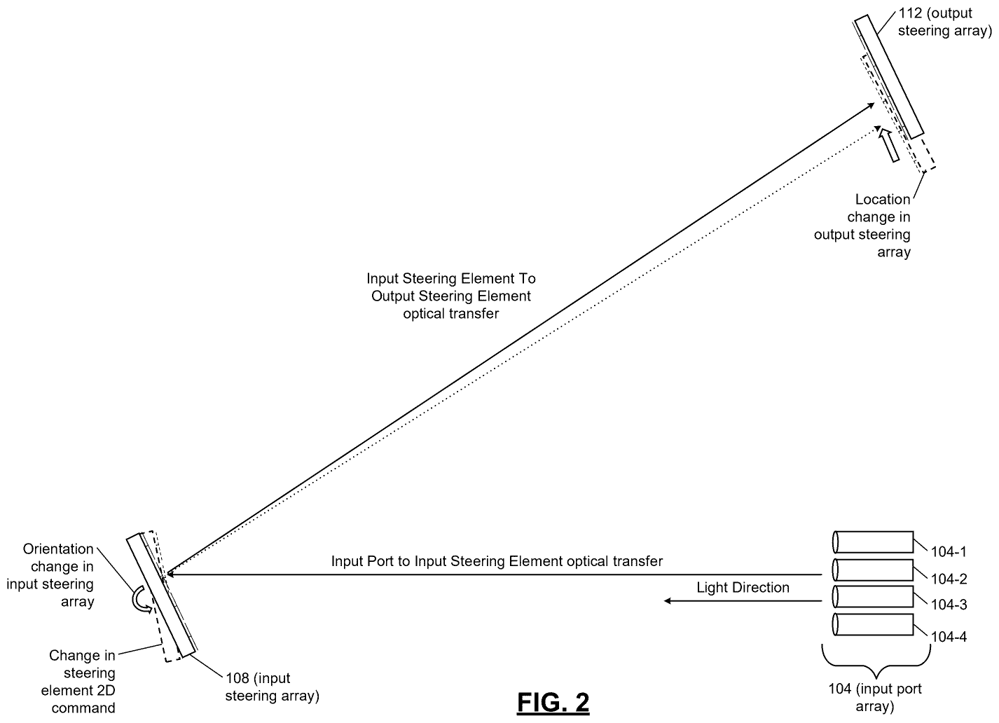

Compensation changes in the position command vectors for a steering array can be grouped by their spatial distribution into two categories: array and sub-array. Array level changes are defined as changes to the position command vectors for any given element which are a function of the spatial location of the element in the steering array. The array level changes follow discernable patterns over the array, such as a constant uniform changes for all elements (owing to the reorientation of the whole array) or lens-like distortion increasing with distance from the center (owing to bow on the array). FIG. 2 depicts an example of array level change (input steering array 108 has changed orientation, and output steering array 112 has changed position).

The order of the array level changes can be thought of as the order of the exponent on the position vector required to define the change as a function of location on the array. For example, a uniform change over the array would be a 0th order array level change as it is independent of location on the array and as such the array level change dθ(r) can be defined as dθ(r)=C*r⁰ (where C is a constant coefficient and r is the radius of the lens). A lens-like distortion increasing with distance from the center (owing to bow on the array) would be a 1st order array-level change as it would be defined with a function of the form dθ(r)=C₀*r⁰+C₁*r¹.

Sub-array level changes do not occur at the array level but instead can vary on an element-by-element basis. Array level changes are easier to measure and mitigate compared to changes at the sub-array level which show no spatial dependence and require unique position command changes for each element in the array. Array level changes can be observed by a limited number of elements then inferred for the other non-measured elements. Sub-array level changes cannot be inferred from other elements and thus pose a much larger problem to precision operation.

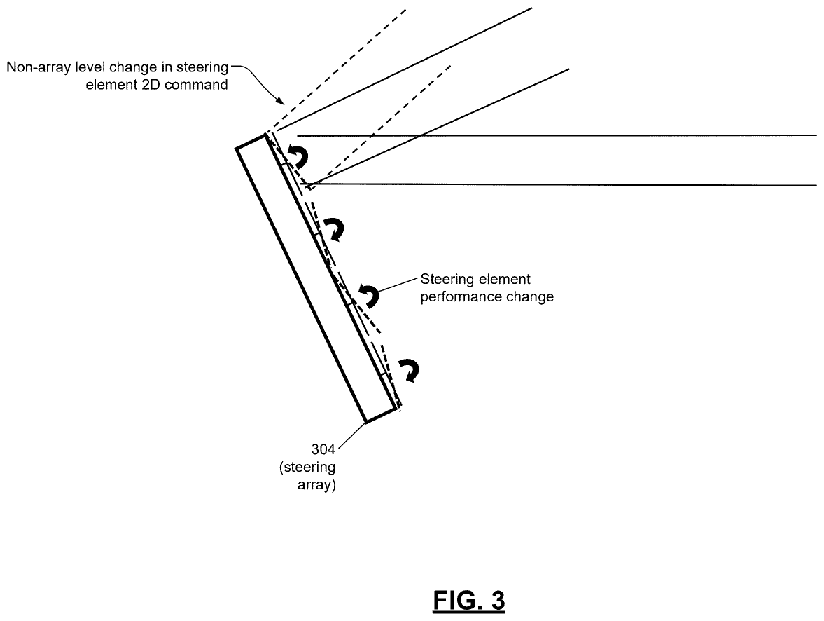

Parameter changes are changes in the defining parameters of the components, such as the electrical-to-mechanical mapping of the steering elements. The compensation of the position command vector for positional changes primarily occurs at the array level. The compensation of the position command vector for the parameter changes (as seen in FIG. 3) often occurs at the sub-array level. In FIG. 3, sub-array level changes have occurred on each of the steering elements of steering array 304, resulting in a sub-array level change in the 2D command corresponding to each steering element. The inference possible with array level changes is relied on by POCCAP, as inference enables indirect prediction of the changes occurring at a given element without requiring in-channel sensing for that element. Effective POCCAP requires that the OCS architecture be designed to suppress sub-array level changes in favor of array level changes. Therefore, parameter changes should generally be mitigated in a POCCAP approach, while positional changes can be tolerated.

The first positional type of change in OCS architecture are in the six degrees of freedom (6DOF) position (location and orientation) of the optical elements. As noted previously, the most common errors in the OCS architecture are generated by location and orientation changes of the fiber, collimator, reflector, lens and/or steering elements. These changes can be compensated for by adjustments of the 4D position command vector (that is, the steering positions of the steering array(s)). In various implementations, some changes (for example, caused by non-linear cases such as aperture clipping) cannot be compensated for by adjusting the 4D position command vector.

This can be understood by examining the primary optical axis of the design. The primary optical axis sets the nominal beam path, with all off-axis behavior effectively modeled as changes relative to the nominal path. Changes in the nominal 4D position command vector can provide the necessary adjustments to re-align the nominal beam path to the changed primary optical axis caused by positional changes of the optical elements. Updates to the command vector required to create a beam parallel to the nominal beam ensure that the optical system always has a consistent response to relative changes around the nominal beam path.

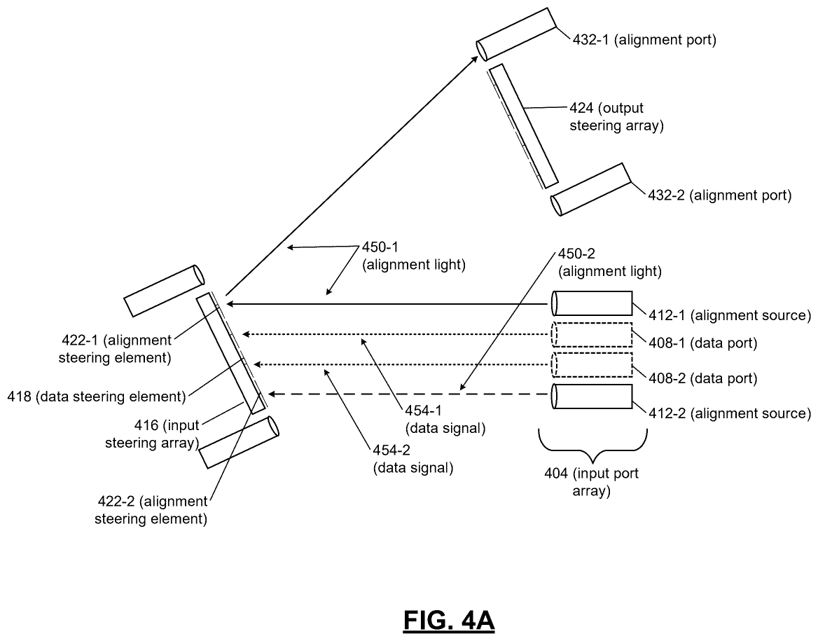

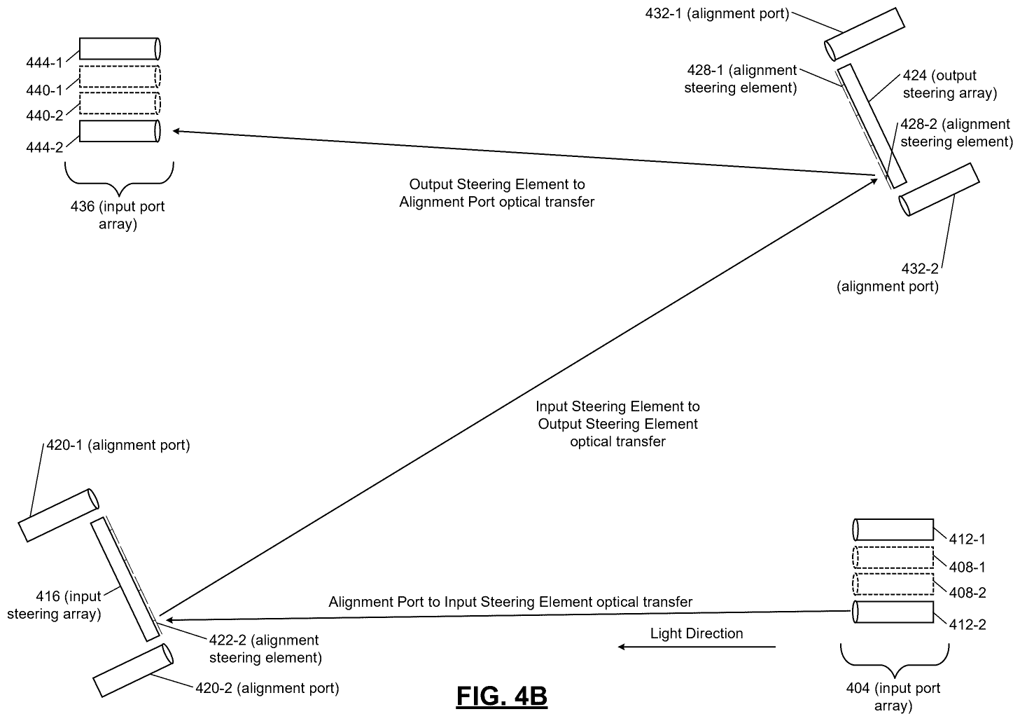

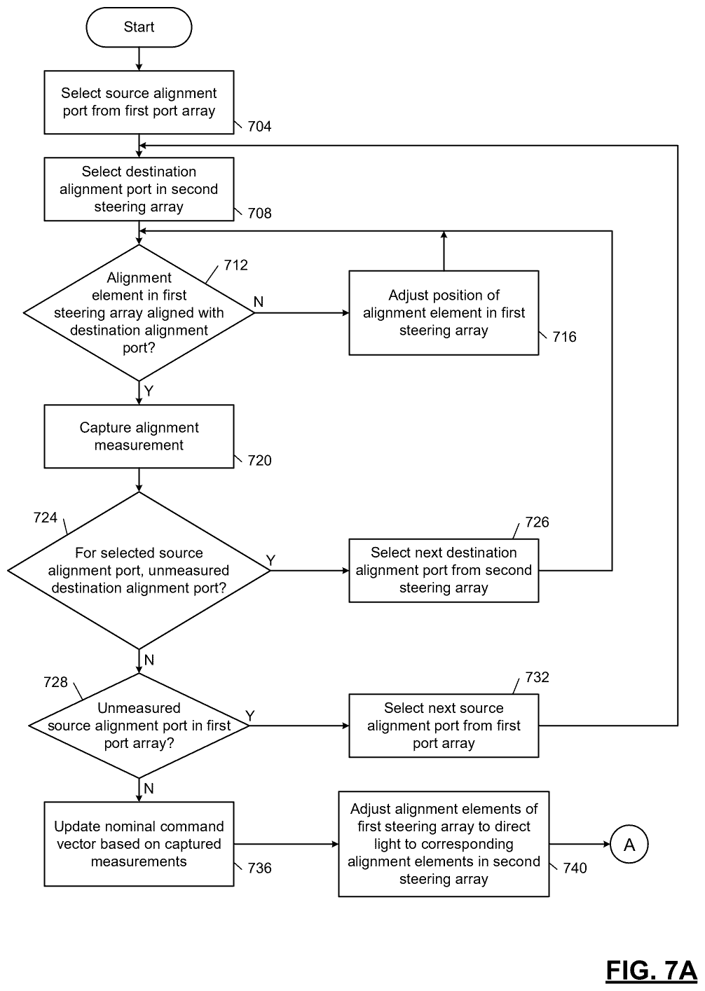

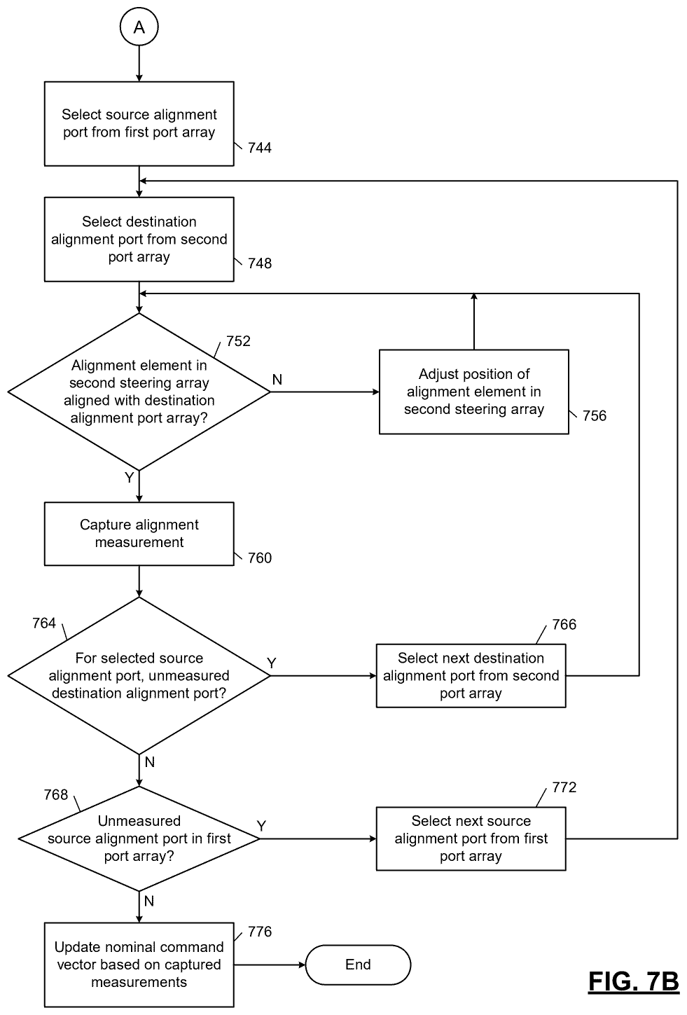

Positional changes of optical elements can be compensated by altering the nominal 4D position command vector (the process for which is described in greater detail below with respect to FIGS. 4A-4B and FIGS. 7A-7B). The nominal 4D position command vector provides a defined 2D nominal position command vector for each of the 2D steering elements. The nominal position command captures the position command for each steering element required to send the beam parallel to the primary optical axis. The relative 4D position command vector for any given port-to-port mapping is defined relative to the nominal position command vector, so the complete port-to-port command combines the nominal and relative position commands. In some implementations, the complete command is determined by adding the nominal command to the relative command. In some implementations, the complete command is determined by tracking the change in the nominal position command vector and adding that change to the relative position command vector. In both cases the nominal position command tracks changes in the nominal beam path and the complete position command combines this change with the constant relative position command. The active compensation adjusts the nominal 4D position command vector that is the baseline term on which all the port-to-port relative 4D position command vectors are defined.

The ability to compensate for all positional changes with changes in the steering element orientation is reviewed for each case (location and orientation). Small scale location changes (dx) of downstream (by dz) optical elements can be mitigated by small scale orientation changes (approximately dx/dz depending on element type and location) of the beam leading to the downstream elements. Small scale orientation changes (dθ) for optical elements produce downstream angle errors which can be mitigated by small scale orientation changes of the beam (approximately −dθdepending on element type and location). Both types of positional changes (location and orientation) can thus be largely compensated by proper adjustment of the steering element position commands. As noted previously, the compensation of the position command vector for optical element positional change occurs at the array level, meaning that it is spatially defined for the elements in the steering array with a uniform value being the most common form. Optical element positional changes alter the primary optical axis for the whole array and thus alter the nominal beam angle (and thus the nominal position command vector) equally for all elements in the steering array.

The second type of change in OCS architecture is in the parameters of the optical elements. The parameter changes cause changes to the position command vectors that generally do not show array-level variation but rather vary on an element-by-element or even port-to-port mapping level. Each of the primary optical elements in the OCS (fiber, collimator, reflector, lens, and steering elements) have performance parameters, such as the fiber core diameter, the collimator lens focal lens, reflector/lens focal length and steering element position command-to-output mapping. Variation in these parameters can alter the 4D position command vector for each input and output port combination in a way that will vary on a sub-array element-by-element level. For example, if a reflector placed between the input and output steering element warps (changing from infinite focal length to a finite value), then the 4D position command vectors for any given port-to-port mapping will change in a way that is not a function of the input steering element location on the array.

Additionally, changes in the steering element parameters including their electrical-to-mechanical behavior will also cause sub-array level changes. Sub-array level changes are not acceptable for POCCAP operation. It is therefore important to use optical elements in the OCS which will be highly stable and not show significant parameter changes. Performance stability is generally easily achieved with passive elements like lens focal lengths, but this can be more difficult with active elements like steering elements. Specifically, steering elements often drift in their electrical-to-mechanical performance but should have a consistent behavior for the POCCAP, such that the electrical-to-mechanical performance is stable over time. POCCAP steering elements must remain continuously calibrated over time. Positional feedback at the element level will result in POCCAP compatible, continuously calibrated, and time stable steering elements.

The requirement for time stability in the elements can be quantitatively defined via the mapping of the performance effect to the beam location on the output fiber. Error propagation analysis of sub-array level performance variations in time should result in negligible insertion loss (much less than 1 dB, preferably less than 0.1 dB) in order to support overall low insertion losses for a high-performance OCS architecture. Time stable optical elements can be defined as elements whose time variation (in a specific environment) that when propagated to link insertion losses show less than 0.1 dB scale effect. This definition is specific to the environment as well as the optical element. Performance changes of concern will appear as changes beam location or orientation change at the output fiber face. If these grow too large, then the variations will cause the beam to lose alignment to the fiber core and lose the link. An OCS design using non-time stable optical elements may function but will have sacrificed much of the potential performance benefit of the POCCAP approach. An OCS designed with time stable optical elements will more effectively exploit the performance benefit of the POCCAP approach.

### Out-of-Channel Sensing

The third feature of POCCAP is the use of out-of-channel sensing (OoCS)—sensing that does not share the optical beam path of any data signal beams through the OCS. This prevents the sensing from interfering with the data signal. In-channel sensing approaches used in other OCS designs impose some alignment penalty, whether through partial measurement failing to observe certain errors or through full measurement attenuating the data signal. The OoCS approach uses dedicated optical sources and sensors located throughout the OCS architecture that can measure changes in the 4D position command vectors but do not interfere with the primary data signal channels.

Optical feedback sensing brings significant cost, complexity, and power requirements to the OCS design. Therefore, it is better to use the minimum required sensing capability for a given OCS architecture. Some in-channel approaches use feedback sensing for every optical channel, leaving the OCS design burdened with significant cost, complexity, power, and optical loss challenges. When the first two features of POCCAP are met (continuous calibration and time stability) for an OCS architecture, then a cascade of benefits accrue. Parameter changes in the OCS architecture are suppressed and therefore the primary architectural changes become position changes (which are array level changes that can be measured at one location and inferred at other locations). The continuous calibration of the elements ensures that relative changes in position command vectors can be transferred, so measured changes in the position command vector for certain sensing elements can be used to infer the necessary changes in the position command vector for the other un-sensed elements.

In some implementations, alignment sensing ports can be located throughout the OCS architecture (as shown in FIGS. 4A-4B) not merely at the port arrays. For example, in some implementations, alignment sensing ports located at the planes of the steering arrays are also useful, as these provide an intermediate measurement of alignment for establishing the nominal 4D position command vector for the steering arrays. Alignment sensing ports at the planes of the steering arrays can be created simply with the end of a fiber mounted onto the steering array frame, such that they capture any light incident on the fiber core. The alignment sensing ports are physically linked to a primary optical element and thus do not inject further alignment error to the measurement. For example, in FIGS. 4A and 4B, input steering array 416 is physically linked to alignment port 420-1 and alignment port 420-2 and output steering array 424 is physically linked to alignment port 432-1 and alignment port 432-2.

Alignment sensing ports should be physically linked to primary optical elements such as the fiber arrays and steering arrays. In other words, sensing ports must have a physical connection to the primary optical element in such a manner that the alignment sensing process, whether from a single port or a combination of measurements from several ports in the same general area of the architecture, measures the position of the physically linked primary optical element. This physical linkage provides a metrology link between the alignment sensing and the important optical element location. As an example, alignment ports linked to the fiber array provide a measure of the positional change of the fiber array, likewise for alignment ports physically linked to the input/output steering arrays or any of the other optical elements. Alignment sensing that is not physically linked to an optical element, as shown in previous approaches to OCS architecture designs, provides a measurement of an unlinked reference feature which is unassociated with any important parts of the architecture. The resulting alignment measurement reads in changes in the un-linked reference feature in addition to changes caused by all other optical elements along the measurement path. The changes in the unlinked reference feature are of no value to ensuring port-to-port alignment and thus can contaminate the measurement process, degrading alignment.

In some implementations, the alignment sensing ports can be wired up to act as either a source or sensor in a switchable manner using a minimal number of sources and sensors such that the system can reallocate the alignment optical source to any set of alignment ports and the alignment sensor to any other set of alignment ports through fiber switches. A well designed POCCAP OCS architecture may only need a single alignment optical source and a single optical sensor. The system can sequentially determine the mapping from source to sensor for each pair, building up an updated map of the nominal 4D position command vector in a matter of seconds, while the positional changes will be occurring at thermal time scales of minutes to hours.

FIGS. 4A-4B show an example of the in-process measurement of the nominal position command vector using intermediate measurements. Each alignment port of input fiber array 404 is sequentially chosen to act as the alignment source (for example, alignment source 412-1 is activated and then alignment source 412-2 is activated). The light (such as alignment light 450-1) from the active fiber array alignment port (alignment source 412-1) shines on a dedicated alignment element (alignment steering element 422-1) in input steering array 416. Alignment steering element 422-1 in input steering array 416 uses a search algorithm to find each of the output steering array alignment sensing ports, one after another. For example, alignment port 432-1 is found and then alignment port 432-2. In some implementations, the search algorithm is an Archimedean spiral which starts at the last known location of the port, then begins an expanding search around that region. When alignment light 450-1 passes over the specially targeted output steering array alignment sensing port (alignment port 432-1), the alignment sensor tracks that a signal has been received and restarts the spiral process around the location corresponding to the alignment element's orientation when the alignment sensor received the signal. This iterative process will converge the beam into alignment and after sufficient iteration that the target is continuously illuminated, can be smoothly adapted to a circular nutation measurement which provides continuous alignment measurement by extracting phase and amplitude as observed by the receiver.

Once the alignment measurement is complete, the beam is shifted to the next alignment sensing port (alignment port 432-2) of output steering array 424. The alignment measurements corresponding to each of the output steering array alignment sensing ports can then be combined to generate the nominal position command vector for the input steering array as seen by the active input fiber array alignment port (alignment source 412-1). In some implementations, output steering array 424 alignment port 432-1 and alignment port 432-2 are symmetrically distributed around output steering array 424, and the average of the alignment measurements can be considered the nominal input steering array position command vector measurement for the given active input fiber array alignment port (alignment source 412-1). This process is repeated for each of the input fiber array alignment ports (for example, repeated with alignment source 412-2, alignment light 450-2, alignment steering element 422-2, alignment port 432-1, and alignment port 432-2), generating redundant measurements of the nominal input steering array position command vector, which can be averaged together to create a single high accuracy nominal input steering array position command vector. The nominal position command vector measures and compensates for positional changes in all the optical elements leading up to the output steering array, including even the location of the output steering array.

In FIG. 4B, the process is repeated for the final leg of the OCS architecture to complete the in-process measurement of all changes. The nominal input steering array position command vector is updated as described above and alignment steering element 422-1 and alignment steering element 422-2 on input steering array 416 are now steered to point at their corresponding alignment steering elements (alignment steering element 428-1 and alignment steering element 428-2) on output steering array 424 through the combination of the nominal with the relative commands. Once again, each alignment port of input fiber array 404 is sequentially chosen to act as the alignment source. This time, the light passes from the input fiber array alignment port to the corresponding input alignment steering element and now to the corresponding output alignment steering element (for example, from alignment source 412-2 to alignment steering element 422-2 to alignment steering element 428-2 on output steering array 424). Alignment steering element 428-2 on output steering array 424 is actuated using a search algorithm to find each alignment sensing port of output fiber array 436, one after another. Once each alignment measurement for a given output fiber array alignment sensing port (for example, alignment port 444-1) is complete, the beam is shifted to the next output fiber array alignment sensing port (for example, alignment port 444-2). As noted previously, the alignment measurements corresponding to each of the output fiber array alignment sensing ports can then be combined to generate the nominal position command vector for the output steering array as seen by the active input fiber array alignment port.

This process can be repeated for each of the input fiber array alignment ports, generating redundant measurements of the nominal output steering array position command vector, which can be averaged together to create a single high accuracy nominal output steering array position command vector. The combination of the nominal input steering array position command vector and the nominal output steering array position command vector provide a full measure of the nominal 4D position command vector.

Alternately, the measurement can be made directly from the input fiber array alignment ports to the output fiber array alignment ports with no intermediate measurements. This process would generate the full 4D position command vector without intermediate measurements, however the approach requires the OCS architecture to be well aligned at the start so that the signal can immediately be observed at the output port. Therefore, this direct end-to-end approach is best used in operation when the scale of change in the OCS architecture is small relative to the frequency of alignment measurements. Each of the input fiber array alignment ports is sequentially chosen to act as the alignment source. The corresponding alignment steering element on the input array is now steered to point at the corresponding alignment steering elements on the output array using the combination of the nominal with the relative commands. The light passes from the input fiber array alignment port to the corresponding input alignment steering element and to the corresponding output alignment steering element. Both the input and output alignment steering elements are now actuated using the previously defined search algorithm to optimize alignment to the target output fiber array alignment port.

This search can be done many ways including simultaneously in a 4D search or sequentially in two steps with a first nutation search of one of the steering elements to find optimal alignment, then a nutation search of the other steering element to find optimal alignment. The end result of the search is the 4D position command vector required for optimal alignment of the corresponding alignment ports. This process can be repeated for each of the output fiber array alignment sensing ports. As noted previously, the alignment measurements corresponding to each of the output fiber array alignment sensing ports can then be combined to generate the 4D nominal position command vector. This process can be repeated for each of the input fiber array alignment ports, generating redundant measurements of the nominal output steering array position command vector, which can be averaged together to create a single high accuracy nominal 4D position command vector.

The entire alignment measurement process can be repeated in the reverse direction, using the output fiber array alignment ports sequentially as the alignment source and working backwards using either of the two approaches described above (intermediate or no intermediate measurements). This reversed direction measurement process produces a redundant measurement of the nominal 4D position command vector that can be used to further improve the accuracy of the overall measurement. POCCAP uses a limited number of alignment sensing channels (for example, less than the number of data ports in the OCS). The number of required alignment sensing channels increases with the order of the array level changes, as more complex array level change must be sensed at more points. It is expected that the primary array level changes will be 0th order uniform changes, meaning that only a very limited number of alignment sensing channels will be required.

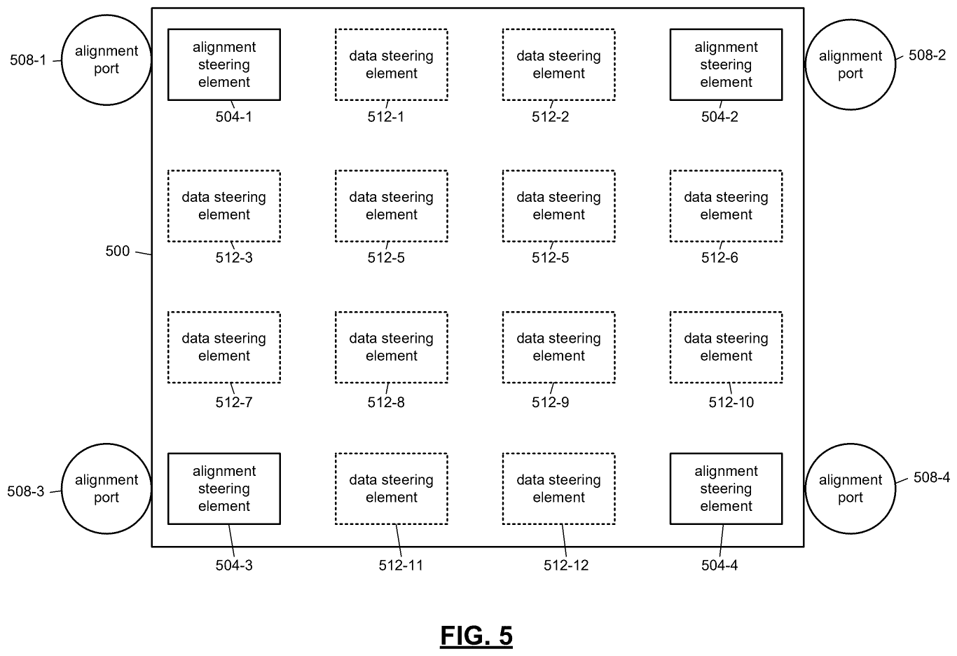

In the simplest case, alignment sensing channels can be implemented at the four corners of the port arrays. The use of the four corners provides redundancy to the measurement, as well as a measure of symmetry by averaging the measurement to mitigate secondary thermal effects. For example, in FIG. 5, steering array 500 includes four alignment ports (alignment port 508-1, alignment port 508-2, alignment port 508-3, and alignment port 508-4) physically linked to the corners of steering array 500. Steering array also includes alignment steering elements (element 504-1, element 504-2, element 504-3, and element 504-4) for directing alignment light. In some implementations, alignment steering elements are located at the corners, middle, and/or sides of a steering array. Steering array also includes data steering elements (512-1-512-12) for directing data signals from input ports to additional steering arrays and/or output port arrays. In some implementations, alignment ports 508-1, 508-2, 508-3, and 508-4 are not located at the corners of the steering array. In some implementations, alignment ports 508-1, 508-2, 508-3, and 508-4 are located symmetrically along the exterior the steering array.

Alignment sensing ports can also be reflectors such as retrocube reflectors to provide a return signal for alignment sensing, this will return the light back down the alignment sensing port it was originally emitted from. Whether the alignment sensing ports are fibers, reflectors, or other optical components such as sources/detectors/chiplets, in all cases they play the same role of creating a reference point upon which the system can align.

In some implementations, the alignment process (updating of the nominal command vector) is carried out while the OCS is operation (i.e., while data is being transmitted). For example, data signal 454-2 from data port 408-2 is received at output port 440-1 via steering elements in input steering array 416 such as data steering element 418 and data steering elements in output steering array 424. In some implementations, data port 408-1 transmits data signal 454-1 and output port 440-2 receives data signals while the alignment occurs.

### Determining the Relative 4D Position Command Vector

The fourth feature of POCCAP is a way to determine the relative 4D position command vector for a given desired data port-to-port alignment. As noted previously, the relative 4D position command vector is combined with the nominal 4D position command vector to produce the complete 4D position command vector for a given port-to-port mapping for data channels. The nominal 4D position command vector can be continuously measured and updated during the operation of the device including during the calibration process.

The relative 4D position command vectors are not as easily discerned. The relative 4D position command vectors must be determined by calibration of the unit prior to regular operation. This calibration process can be carried out by supplying an optical signal to each input port sequentially then using initial estimates combined with the nominal position command vector and a search algorithm to find the best fit relative 4D position command vector for each output data port. This process produces a specific measured relative 4D position command vector for any given input and output port combination. The results of the process can be compared to the nominal position command vector, and the comparison (generally the difference) stored in a number of different ways including as a full lookup table or turned into a function with fit parameters. In all cases, the result is a defined relative 4D position command vector for any given input and output port combination.

The calibration process involves a full search through 4D space which can be time consuming. This process can be accelerated by using the intermediate reference features, the input/output steering array alignment sensing ports. The input steering element for a given input data channel can be scanned over the output steering array to find alignment to the output steering array alignment ports. Once this alignment is found, the desired output steering element is more easily located as a relative change. Now all that remains is the output steering element adjustment to align the beam into its corresponding port. This process of using the input/output steering array alignment sensing ports breaks the full 4D space search into a more efficient process of two sequential 2D space searches. The net result is the same relative 4D position command vector identification for the given input and output port combination.

In some implementations, the alignment process can be performed with data port 408-1 and data port 408-2 in addition to alignment source 412-1 and alignment source 412-2. For example, data port 408-2 emits light which is reflected from data steering element 418 on input steering array 416 into alignment port 432-1 and then alignment port 432-2. These measurements are recorded and averaged and used to update the relative command vector for the specific data port. This process can be repeated with each data port and its corresponding data steering element and each alignment port.

The input/output steering array alignment sensing ports provide another benefit of providing a mechanism for in-situ measurement of fiber-collimator parameter change and recalibration. If the fiber moves relative to the collimator element, this changes the collimated beam direction and appears as a sub-array level element-by-element change. The OCS architecture can track these changes by the same approach used to find the nominal position command vector for the input steering array. A signal of any kind (including data) can be sent into the data channel of concern (m), then the corresponding input steering element can be steered to align to the output steering array alignment sensing ports. The net measurement from all these ports provides a measure of the nominal position command vector for that steering element (m). The OoCS measurement of the input steering array nominal position command vector should fully track all changes in the newly measured nominal position command vector. Any change not accounted for by the nominal position command vector measurement can be considered a change to the stable optical parameters of that mth data channel and that change can be applied to the lookup table for all the position commands which use the mth input steering element. In this way, the OCS architecture can be recalibrated in-situ by sequentially rerouting the data channels to the reference ports (taking them out of operation for a few fractions of a second), recalibrating and bringing them back online. This can be done when channels are not in use during regular operation. The same way works in reverse for recalibrating the output steering array by sending signals into the nth data channel and aligning these to the input steering array alignment sensing ports. For both directions this is an out-of-channel sensing approach as the data channel is not passing any usable data while this recalibration is being carried out, so the alignment signal is not sharing the path with any data signals.

### Block Diagram

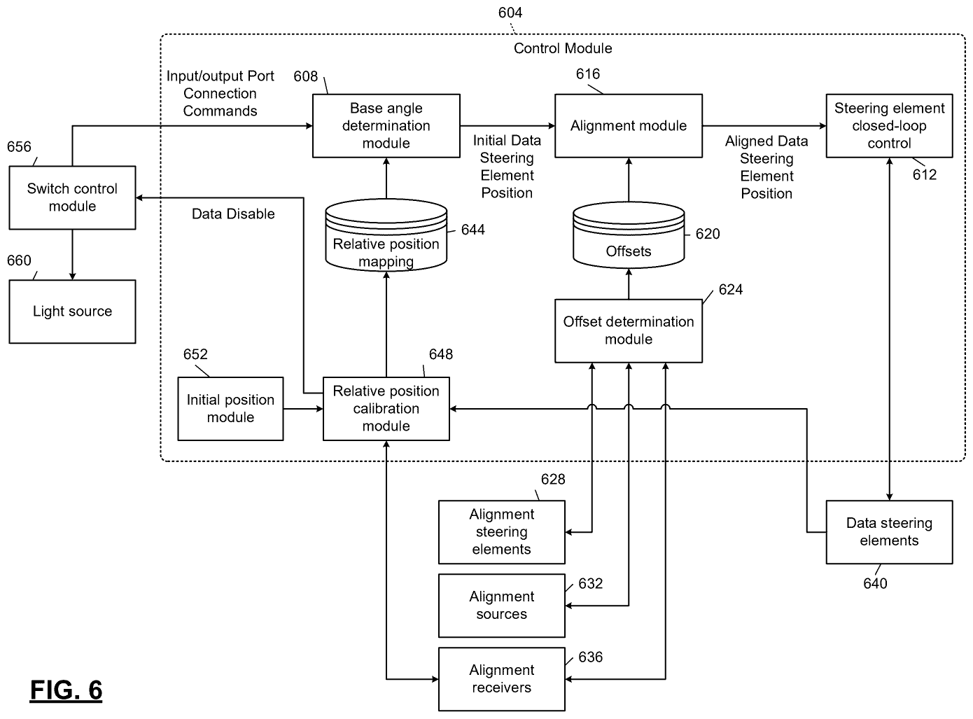

FIG. 6 is a block diagram of an example system for precision out-of-channel-sensing. Control module 604 receives input/output connection commands at base angle determination module 608 from switch control module 656. Base angle determination module references the relative command vector look-up table (LUT) stored in relative position mapping database 644 and sends the initial data steering element position command (i.e., the relative command vector) for the steering elements that correspond to the request input/output combination. Relative command vector LUT stores position commands for connecting any input port with any output port (by adjusting data steering elements 640 on one or more steering arrays). In some implementations, relative command vector LUT is configured as a matrix and the command to connect input m with output n is stored at position [m, n] in the matrix.

The initial relative command vector stored in relative position mapping database 644 is provided by initial position module 652, which determines the initial relative command vector (e.g., at the time of assembly). Relative position mapping database 644 can be updated with data from relative position calibration module 648. Relative position calibration module 648 communicates with data steering elements 640 and/or alignment receivers 636 to update the relative command vector by performing a process similar to the alignment process described in FIGS. 7A-7B. Relative position calibration module 648 sends a data disable signal to switch control module 656 so that light source 660 (i.e., input and/or output ports used to transmit data signals) transmits a light beam instead of a data signal. In some implementations, the light from light source 660 is a steady light source, which enables detection of the light source more easily than a light source that might turn off and off as with data signals. Light source 660 (e.g., an input or output port) is shone onto the corresponding data steering element (e.g., a steering element of data steering elements 640), and directed to alignment receivers 636 on a second steering array and/or data port array. Data steering elements 640 are actuated until the light is directed into each receiver of alignment receivers 636. The position of the steering element when aligned with each receiver of alignment receivers 636 is recorded and averaged and used to update the relative command vector.

The initial data steering element position command is adjusted at alignment module 616. Alignment module 616 adjusts the initial data steering element position command by summing the initial command with the measured positional offsets (i.e., the nominal command vector) stored in offset storage 620. Offset storage 620 communicates with offset determination module 624, which uses data from alignment steering elements 628, alignment sources 632, and alignment receivers 636 to detect array-level alignment changes in the OCS architecture. Alignment module 616 also manages element-level changes by measuring steering element positional changes via steering element calibration components 612 and adjusting the calibration and position of steering elements as necessary. Steering element calibration feedback is provided by steering element calibration components 612 on alignment steering elements 628 and data steering elements 640. In some implementations, steering element calibration components 612 are capacitors attached to each element of alignment steering elements 628 and each element of data steering elements 640.

In some implementations, alignment receivers 636 are combined with alignment sources 632 resulting in elements capable of sensing and creating alignment signals. In some implementations, alignment receivers 636 and alignment sources 632 are separate elements that are physically linked. In some implementations, alignment receivers 636 and alignment sources 632 are physically linked to the output port arrays, input port arrays, and/or steering arrays that hold alignment steering elements 628 and data steering elements 640 of the OCS. In some implementations, alignment receivers 636 and alignment sources 632 are located at the corners of the output port arrays, input port arrays, and/or steering arrays. In some implementations, alignment receivers 636 and alignment sources 632 are attached to the four corners of the input port array, the output port array, and/or the alignment steering array containing alignment steering elements 628 and data steering elements 640.

### Flowcharts

FIGS. 7A-7B are a flowchart of an example method for aligning out-of-channel sensing elements and updating the nominal command vector. While the method below describes the use of fibers at the optical data channel ports, other light sources and detection methods can be used. In various embodiments, an input and/or output port includes a single optical data source. In various embodiments, an input port includes two or more optical data sources. For example, an input and/or output port may include a bundle of optical sources (such as fiber, lasers, etc.) pointed at a single steering element, which results in more sources than steering array elements. In various embodiments, each source of the bundle of optical sources corresponds to a collimator unique to the source.

The method begins at 704 where control selects a source alignment port (i.e., an alignment signal source) from a first port array (for example, an alignment port physically linked to the input port array). At 708, control selects a destination alignment port in the second steering array (for example, the output steering array). At 712, control determines if the alignment element (that corresponds to the source alignment port) in the first steering array (for example, the input steering array) is aligned with the destination alignment port in the second steering array. If alignment has been achieved, control transfers to 720. If alignment has not been achieved, control transfers to 716 where the position of the alignment element in the first steering array is adjusted and control transfers to 712.

At 720, control captures the alignment measurement (i.e., the position of the alignment element the enables the alignment signal to travel from the source alignment port to the destination alignment port). At 724, control determines if there are unmeasured destination alignment ports in the second steering array (i.e., has the port alignment signal source been aligned with all destination alignment ports in the second steering array). If there are unmeasured destination alignment ports in the second steering array, control transfers to 726 where the next destination alignment port is selected. If all destination alignment ports on the second steering array have been aligned with the selected source alignment port, control transfers to 728. At 728, control determines if all source alignment ports from the first port array have been measured. If there is an unmeasured source alignment port remaining, control transfers to 732. If there are no unmeasured source alignment ports remaining, control transfers to 736.

At 732, control selects the next source alignment port (for example, the next alignment port in the input port array) and control continues to 708. At 736 the nominal command vector is updated based on the collected measurements. At 740, control adjusts the position the alignment elements of the first steering array (using the updated nominal command vector) to align with the corresponding alignment elements in the second steering array (i.e., so that the signals from the source alignment ports are reflected from the corresponding alignment steering elements in the first steering array to the corresponding alignment steering elements in the second steering array).

At 744, control selects a source alignment port from the first port array (for example, an alignment port physically linked to the input port array). At 748, control selects a destination alignment port from the second port array (for example an alignment port physically linked to the output port array). At 752, control determines if the steering element in the second steering array (for example an alignment steering element in the output steering array) is aligned with the alignment port in the second port array (for example the output port array). If not, control transfers to 756 adjusts the position of the alignment steering element in the second steering array and control returns to 752. If the alignment steering element in the second steering array is aligned with the alignment port in the second port array, control transfers to 760. At 760, control captures the alignment measurement (i.e., the position of the alignment element in the second steering array the allows the signal from the source alignment port to reach the destination alignment port in the second port array).

At 764, control determines if there are unmeasured destination alignment ports in the second port array (i.e., has the currently elected source alignment port been aligned with all destination alignment ports). If the selected source alignment port has not been aligned with all destination alignment ports, control transfers to 766. At 766, control selects the next destination alignment port from the second port array. If the selected source has been aligned with all destination alignment ports, control transfers to 768. At 768 control determines if there are source alignment ports that have not been measured. If yes, control transfers to 772 and the next source alignment port is selected and control continues to 748. If there are no unmeasured source alignment ports (i.e., all source alignment ports in the first port array have been aligned with all destination alignment ports in the second port array), control transfers to 776. At 776 control updates the nominal command vector based on the captured measurements and control ends.

In some implementations, the method is executed by aligning alignment ports physically linked to the input ports with alignment ports physically linked to the output steering array (via alignment steering elements on the input steering array) and then finally with alignment ports physically linked to the output port array (via alignment steering elements on the output steering array). In some implementations, the method is executed in the opposite direction by aligning alignment ports physically linked to the output port array with alignment ports physically linked to the input steering array (via alignment steering elements on the output steering array) and then finally with alignment ports physically linked to the input port array (via alignment steering elements on the input steering array). In some implementations, the process is completed in both directions. In some implementations, the method is executed repeatedly, for example once every 0.1, 0.2, 0.5, 1, 2, 3, 4, 5 and/or 10 seconds. For systems in high vibration environments, the measurements might be carried more quickly, such as every 0.001 seconds.

FIG. 8 is a flowchart of an example method of maintaining steering element calibration within the OCS. At 804 control begins and determines if a position input for an element as begin received (as part of a connection request). If no position input as been received, control remains at 804. If a position input for an element has been received, control transfers to 808. At 808, control sends the position command to the element. At 812, control measures the element position (via continuous feedback). At 816, control determines if the element position is correct. If the element position is correct, control transfers to 812. If the position is incorrect, control transfers to 820 and adjusts the element position. Control then returns to 812.

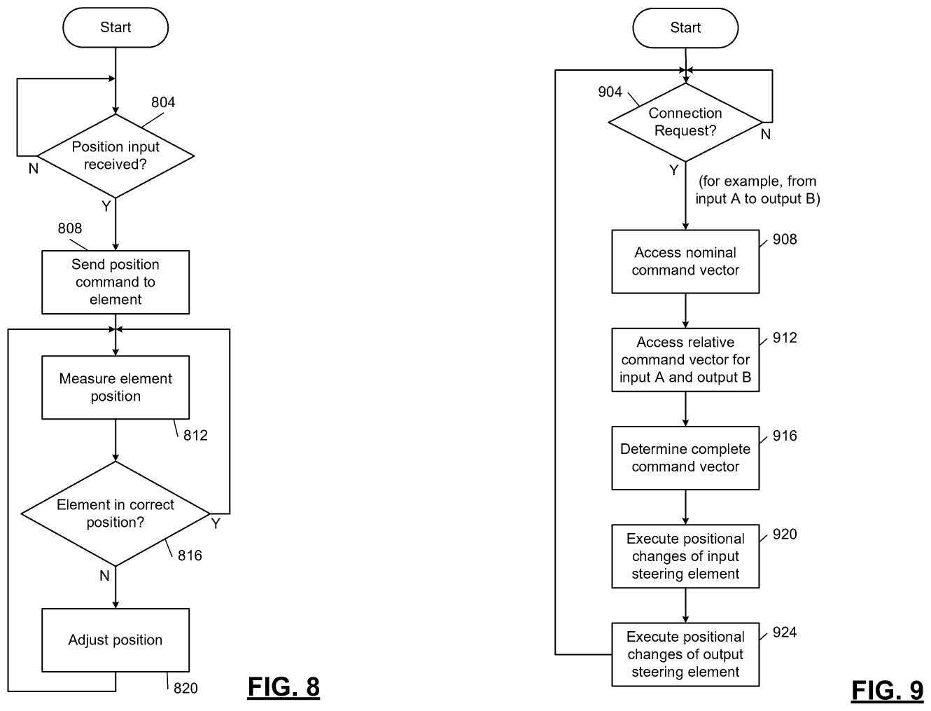

FIG. 9 is a flowchart for an example method for aligning an optical input port with an optical output port. The method begins at 904 and control determines whether a connection request has been received. If yes, control transfers to 908. If no, control remains at 904. In some implementations, a connection request is a request to connect a particular input port with a particular output port (for example, input A to output B). At 908, control accesses the nominal command vector. At 912, control accesses the relative command vector for the commands to move the steering elements associated with the requested input port (input A) and the requested output port (output B) so that light from the input port is received at the output port. Control continues to 916, where the complete command vector is determined by summing the nominal command vector and the relative command vector. Then control continues to 920 and executes the command vector, aligning the input steering elements so that the optical beam is directed to the correct output steering element. At 924, control continues to execute the command vector and aligns the output steering element with the request output port so that the requested input and requested outputs are optically connected (i.e., light from input port A is received at output port B). Control then returns to 904.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python@.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A system for aligning optical signals, the system comprising:
a set of data sources,
a set of data receivers,
a set of alignment signal sources,
a set of alignment signal receivers,
a first steering array including:
a set of alignment steering elements, each configured to:
adjustably direct incident light in a specified direction, and
for each alignment steering element of the set of alignment steering elements:
reflect light from a set of light sources, and
adjust the alignment steering element until the reflected light incident on a respective receiver is maximized; and
a plurality of data steering elements each configured to direct a set of signals from a respective subset of sources of the set of data sources in a respective specified direction; and
a command controller configured to:
determine, based on adjustments from the set of alignment steering elements, a change in a nominal position command vector;
determine an overall command vector for an optical path between a selected set of data sources of the set of data sources and a selected set of data receivers of the set of data receivers based on:
the change in the nominal position command vector, and
a first command based on information encoding a set of relative position commands, wherein the first command corresponds to a combination of the selected set of data sources and the selected set of data receivers; and
establish the optical path between the selected set of data sources and the selected set of data receivers by executing the overall command vector.

2. The system of claim 1 wherein:
each alignment steering element of the set of alignment steering elements is configured to reflect light from a plurality of light sources, and
each data steering element of the set of alignment steering elements is configured to direct a plurality of signals from the respective subset of sources.

3. The system of claim 1 wherein:
the set of data sources includes a set of light stations each configured to transmit and detect light simultaneously, and
the set of data receivers includes a set of light stations each configured to transmit and detect light simultaneously.

4. The system of claim 1 wherein the respective subset of sources includes a bundle of optical fibers.

5. The system of claim 1 wherein each data source of the set of data sources corresponds to a unique collimator.

6. The system of claim 1 further comprising a second steering array wherein:
the specified direction corresponds to the second steering array, and
the respective receiver is physically linked to the second steering array.

7. The system of claim 6 wherein:
the first steering array is physically linked to a first subset of alignment signal sources and a first subset of alignment signal receivers,
the second steering array is physically linked to a second subset of alignment signal sources and a second subset of alignment signal receivers,
the set of data sources are physically linked to a third subset of alignment signal sources and a third subset of alignment signal receivers, and
the set of data receivers are physically linked to a fourth subset of alignment signal sources and a fourth subset of alignment signal receivers.

8. The system of claim 1 further comprising a set of calibration elements, wherein:
a first element of the first steering array includes a first subset of calibration elements,
the first element is maneuvered via a set of paddles, and
a position of the set of paddles is indicated by the first subset of calibration elements.

9. The system of claim 8 wherein determining the overall command vector includes summing the nominal position command vector and the first command of the set of relative position commands.

10. The system of claim 1 wherein each member of the set of relative position commands corresponds to a combination of one input source of the set of data sources and one data receiver of the set of data receivers.

11. The system of claim 1 wherein the set of relative position commands includes a respective command for every possible combination of one data source of the set of data sources and one data receiver of the set of data receivers.

12. The system of claim 1 wherein the command controller is configured to determine the overall command vector in response to a request that designates the selected set of data sources and the selected set of data receivers.

13. The system of claim 1 wherein the set of alignment steering elements is repeatedly calibrated and the plurality of data steering elements are repeatedly calibrated.

14. The system of claim 1 wherein the set of data sources, the set of data receivers, set of alignment signal sources, the set of alignment signal receivers, the set of alignment steering elements, and the plurality of data steering elements are time stable.

15. The system of claim 1 wherein the nominal position command vector includes commands to align a first data source of the set of data sources with a corresponding data receiver of the set of data receivers.

16. The system of claim 1 wherein the plurality of data steering elements are each configured to:
adjustably direct incident light in a specified direction, and
for each alignment steering element of the set of alignment steering elements:
reflect light from a set of light sources, and
adjust the alignment steering element until the reflected light incident on a respective receiver is maximized.

17. The system of claim 16 wherein the command controller is configured to:
store adjustments from the plurality of data steering elements, and
determine, based on the stored adjustments from the plurality of data steering elements, a change in the set of relative position commands.

18. The system of claim 1 wherein the set of data sources and the set of data receivers include a set of fiber optic cables.

19. The system of claim 1 wherein the command controller is configured to determine adjustments based on data from the set of alignment steering elements.

20. The system of claim 1 wherein the command controller is configured to receive the adjustments from the set of alignment steering elements.

21. The system of claim 1 wherein the information encoding the set of relative position commands includes at least one of:
a look-up table,
an equation, or
stored information.

22. A method for aligning optical signals of an optical system, the method comprising:
adjustably directing incident light, via a set of alignment steering elements of a first steering array, in a specified direction by:
for each alignment steering element of the set of alignment steering elements:
reflecting light from a set of light sources, and
adjusting the alignment steering element until the reflected light incident on a respective receiver is maximized,
for each data steering element of a plurality of data steering elements of the first steering array, directing a set of signals from a respective subset of data sources of a set of data sources in a respective specified direction,
determining, based on adjustments from the set of alignment steering elements, a change in a nominal position command vector,
determining an overall command vector for an optical path between a selected set of data sources of the set of data sources and a selected set of data receivers of a set of data receivers based on:
the change in the nominal position command vector, and
a first command of a set of relative position commands, wherein the first command corresponds to a combination of the selected set of data sources and the selected set of data receivers, and
establishing the optical path between the selected set of data sources and the selected set of data receivers by executing the overall command vector.

23. The method of claim 22 wherein:
the specified direction corresponds to a second steering array,
the respective receiver is physically linked to the second steering array,
the first steering array is physically linked to a first subset of alignment signal sources and a first subset of alignment signal receivers,
the second steering array is physically linked to a second subset of alignment signal sources and a second subset of alignment signal receivers,
the set of data sources are physically linked to a third subset of alignment signal sources and a third subset of alignment signal receivers, and
the set of data receivers are physically linked to a fourth subset of alignment signal sources and a fourth subset of alignment signal receivers.

24. The method of claim 22 wherein:
a first element of the first steering array includes a first subset of calibration elements,
the first element is maneuvered via a set of paddles,
a position of the set of paddles is indicated by the first subset of calibration elements,
determining the overall command vector includes summing the nominal position command vector and the first command of the set of relative position commands,
each member of the set of relative position commands corresponds to a combination of one input source of the set of data sources and one data receiver of the set of data receivers,
the set of relative position commands includes a respective command for every possible combination of one data source of the set of data sources and one data receiver of the set of data receivers, and
the nominal position command vector includes commands to align a first data source of the set of data sources with a corresponding data receiver of the set of data receivers.

25. A non-transitory computer-readable storage medium storing processor-executable instructions, the instructions comprising:
adjustably directing incident light, via a set of alignment steering elements of a first steering array, in a specified direction by:
for each alignment steering element of the set of alignment steering elements:
reflecting light from a set of light sources, and
adjusting the alignment steering element until the reflected light incident on a respective receiver is maximized,
for each data steering element of a plurality of data steering elements of the first steering array, directing a set of signals from a respective subset of data sources of a set of data sources in a respective specified direction,
determining, based on adjustments from the set of alignment steering elements, a change in a nominal position command vector,
determining an overall command vector for an optical path between a selected set of data sources of the set of data sources and a selected set of data receivers of a set of data receivers based on:
the change in the nominal position command vector, and
a first command of a set of relative position commands, wherein the first command corresponds to a combination of the selected set of data sources and the set of selected data receivers, and
establishing the optical path between the selected set of data sources and the selected set of data receivers by executing the overall command vector.

26. The non-transitory computer-readable storage medium of claim 25 wherein:
the specified direction corresponds to a second steering array,
the respective receiver is physically linked to the second steering array,
the first steering array is physically linked to a first subset of alignment signal sources and a first subset of alignment signal receivers,
the second steering array is physically linked to a second subset of alignment signal sources and a second subset of alignment signal receivers,
the set of data sources are physically linked to a third subset of alignment signal sources and a third subset of alignment signal receivers, and
the set of data receivers are physically linked to a fourth subset of alignment signal sources and a fourth subset of alignment signal receivers.
